(19) United States
(12) Patent Application Publication
(10) Pub. No.: US 2025/0054057 A1
(43) Pub. Date: Feb. 13, 2025

(54) HEURISTIC IDENTIFICATION OF MISSING CAUSAL EVENTS

(71) Applicant: Capital One Services, LLC, McLean, VA (US)

(72) Inventors: Russell DANNA, Rockwall, TX (US); Michael GARNER, Carrollton, TX (US)

(73) Assignee: Capital One Services, LLC, McLean, VA (US)

(21) Appl. No.: 18/232,018

(22) Filed: Aug. 9, 2023

(51) Int. Cl. G06Q 40/02

(52) U.S. Cl. CPC G06Q 40/02

(57) ABSTRACT

Validating operations are described that determines a first difference between a first data set and a second data set, determines an action associated with the first difference, applies the action to at least one of the first data set and the second data set, determines a second difference between the first data set and the second dataset after applying the action and presents the information including the action applied to at least one of the first data set and the second data set after determining that the second difference satisfies predetermined criteria.

### BACKGROUND

A validation system compares two resultant data sets against one another to validate that events affecting the data set are properly reflected in the current data set. For example, the validation system compares the ledger output of two systems for account reconciliation after each system accepts a series of transactions. In other instances, for documents created with the addition of several actions, such as documents created in a text editor, the validation system may also need to compare the documents to identify differences due to differences in version, management system, and management location.

When the validation system finds a mismatch, a root cause analysis can be a painstaking task of trying to deduce which system is missing a particular event that yielded the discrepancy between the two outputs.

### BRIEF DESCRIPTION OF THE DRAWINGS/FIGURES

The present disclosure is described with reference to the accompanying drawings. In the drawings, like reference numbers indicate identical or functionally similar elements. Additionally, the left most digit(s) of a reference number identifies the drawing in which the reference number first appears. In the accompanying drawings:

FIG. 1 illustrates an overview of a validation system according to some embodiments of the present disclosure;

FIG. 2 illustrates a flowchart of the validation system according to some embodiments of the present disclosure;

FIG. 3 illustrates a state transition diagram of the validation system according to some embodiments of the present disclosure;

FIG. 4 illustrates a continuation of the state transition diagram of the validation system according to some embodiments of the present disclosure;

FIG. 5 illustrates a continuation of the state transition diagram of the validation system according to some embodiments of the present disclosure;

FIG. 6 is an example processor system for implementing some aspects or portion(s) thereof.

The present disclosure will now be described with reference to the accompanying drawings.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition does not in itself dictate a relationship between the various embodiments and/or configurations discussed.

### 1. OVERVIEW OF A VALIDATION SYSTEM

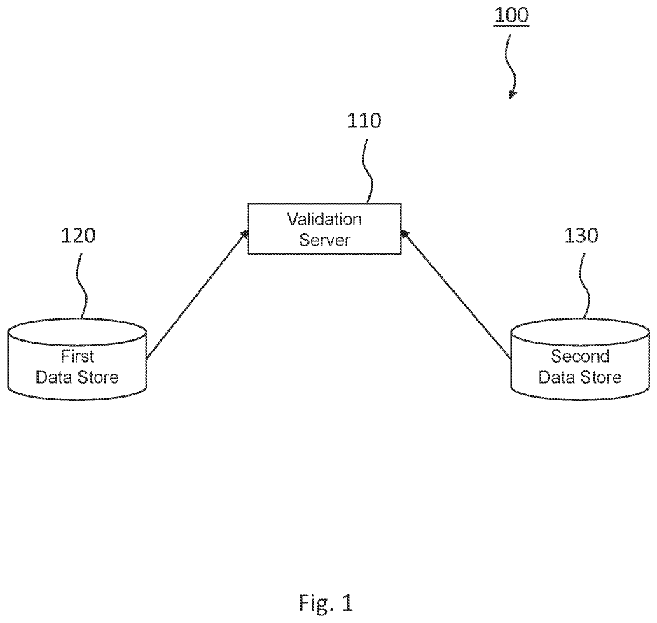

This disclosure is applicable to apparatuses, systems, methods, and computer-readable storage devices that perform validation operations. In the following, FIG. 1 is used to illustrate an example of a multilink operation.

FIG. 1 illustrates an overview of a validation system according to some embodiments of the present disclosure. This disclosure describes an example in which the validation server performs reconciliation in a bank as an example of a business field.

A validation system 100 is a system for performing validation operations. The validation system 100 comprises a validation server 110, a first data store 120, and a second data store 130. As will become clear in future explanations, this disclosure is broadly applicable beyond bank reconciliation operations. The disclosure is widely applicable to the technical field of finding discrepancies between data generated by multiple actions and identifying the action that caused the discrepancy. Examples of technical fields to which this disclosure is applicable include, but are not limited to, difference validation in document creation software, difference validation in database software, difference validation of source code, debugging operations, etc.

Validation server 110 validates mismatches between the first data store 120 and the second data store 130 and determines the cause of the discrepancies. The first data store 120 and the second data store 130 are data stores used by different systems in one embodiment. In this embodiment, the first data store 120 and the second data store 130 record a particular account's ledger balance at a given time. The first data store 120 and the second data store 130 thereafter sends the particular ledger balance to the validation server 110. Validation server 110 validates the differences between the ledger balances. Although the first data store 120 and the second data store 130 were originally created by different systems, they should match because they reflect the same actions. The fact that these states are different means that some actions were applied to only one of them. In this disclosure, validation is performed by identifying the action that formed this difference.

The state of the first data store 120 at a particular point in time in this embodiment is included in state A of this disclosure. Each item name and value set of the ledger balance at that state A or the set of such sets in this embodiment are included in the first data set of this disclosure. Similarly, the state of the second data store 130 at the particular point in time in this embodiment is included in state B of this disclosure. Each item name and value set of the ledger balance at that state B or the set of such sets in this embodiment are included in the second data set of this disclosure.

Again, this disclosure is widely applicable to the technical field of finding discrepancies between data generated by multiple actions and identifying the action that caused the discrepancy. Thus, the terms state A, B or the first or the second data set should not be interpreted to mean only the specific implementation of one of the above examples. For example, if this disclosure were applied to the technical field of creating a given deliverable, a person having ordinary skill in the technical field would have understood that it is possible to interpret the different states of the deliverable as being included in state A, B, etc., and that it is possible to interpret the specific data set that the deliverable has as being included in the first or second etc. data set.

### 2. VALIDATION OPERATION OF THE SYSTEM

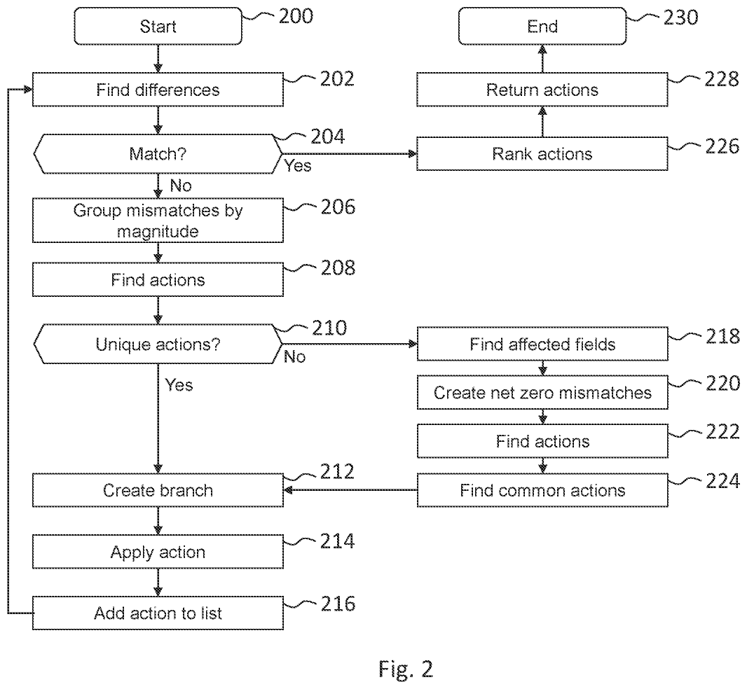

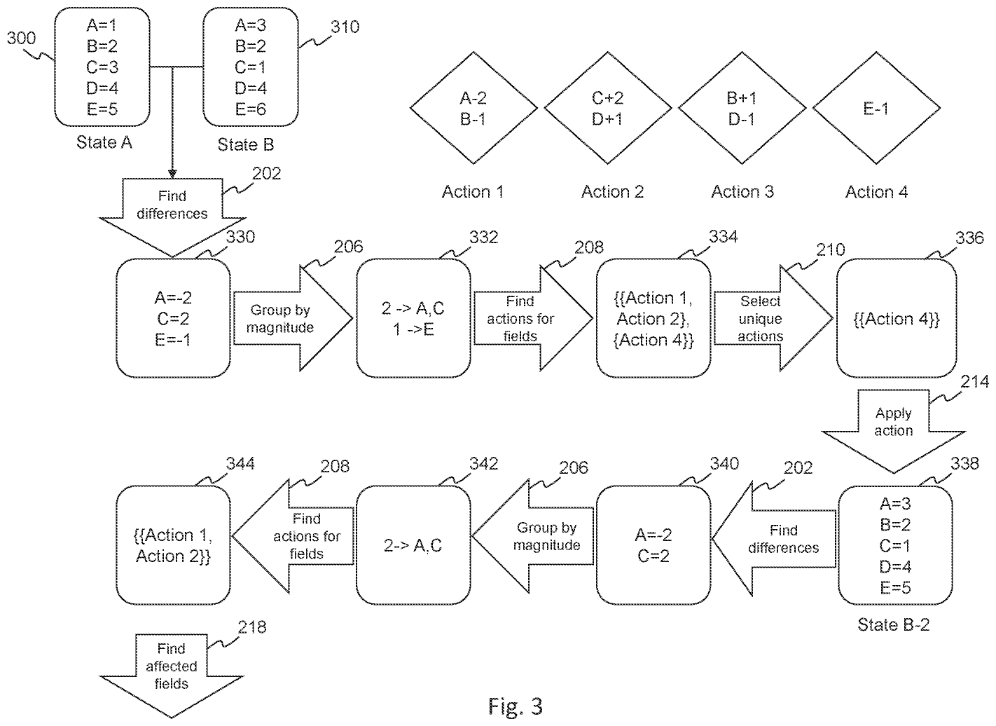

This section shows operations of the validation system 100. In this embodiment, for a better understanding of the nature of the disclosure, the flowchart shown in FIG. 2 and the state transition diagrams shown in FIG. 3 through FIG. 5 are referenced simultaneously for an explanation.

FIG. 2 illustrates a flowchart of the validation system according to some embodiments of the present disclosure. Unless otherwise noted, the validation server 110 will be described as being the subject of the operations in the flowchart, but other elements within or added to the validation system 100 may perform or work together to perform the operations in the flowchart.

At operation 200, the validation server 110 starts the validation operation. In this embodiment, the validation operation is performed under the conditions described in FIG. 3s through FIG. 5, as follows.

FIG. 3 through FIG. 5 illustrate state transition diagrams of the validation system, according to some embodiments of the present disclosure. State A 300 and State B 310 represent information sent from the first data store 120 and the second data store 130 to the validation server 110. State A 300 is a ledger balance of a specific account, with values 1, 2, 3, 4, and 5 for fields A, B, C, D, and E. State B 310 is a ledger balance of the specific account, with values 3, 2, 1, 4, and 6 for fields A, B, C, D, and E. respectively. In the above description, the fields represent, for example, account items. In the above description, the values represent balances for example. State A and State B are examples of the first and second data sets in this disclosure.

Actions 1 through Actions 4 are actions that are represented by manipulation of the data over the fields. For example, Action 1 means that when it is executed, it will reduce field A's value by two and field B's value by one. In the above description, Actions represent, for example, transactions.

At operation 202, the validation server 110 finds the difference between State A and State B. As already mentioned, although State A and State B were originally created by different systems, they should match because they reflect the same actions. The fact that these states are different means that there was a difference in the actions performed for at least one of the States. In this disclosure, validation is performed by identifying the action that formed this difference. As shown in a result 330 in FIG. 3, by performing operation 202 to State A 300 and State B 310, the validation server 110 finds a difference of 2 in the field A and the field C, and −1 in the field E. In this disclosure, the difference found first is referred to as the first difference, and the differences found thereafter are referred to as the second difference for convenience.

At operation 204, the validation server 110 determines whether there is a match with compared states. As shown in the result 330 in FIG. 3, there was no match between State A and State B; therefore, the process proceeds to operation 206 (“No” at operation 204.) In this disclosure, the word “match” does not necessarily mean an exact match. The degree of difference to be considered a “match” depends on the technical field to which this disclosure is applied. For example, if the difference meets certain criteria, it may be treated as a “match”. For example, in the field of banking accounts as described in this embodiment, the “match” may mean an exact match, but, for instance, in natural language processing and other applications, a “match” may be identified when a portion matches or exceeds a predetermined threshold.

At operation 206, the validation server 110 groups mismatches by magnitude. As shown in a result 332 in FIG. 3, by performing operation 206 to the result 330, the validation server 110 groups the mismatches in the fields A and C as both having magnitude 2, and groups the mismatch in the field E as having magnitude 1.

At operation 208, the validation server 110 finds actions for groups of fields found in operation 206. If an action manipulates at least one of the fields found in operation 206, the action is found as the action for the field. In other words, the validation server 110 determines actions associated with the first difference. Since the result 332 shows the group of the fields A and C, and the group of the field E, the validation server 110 finds actions, which affect these fields. As shown in a result 334, the validation server 110 finds a group of Action 1 and Action 2 for the group of the fields A and C and a group of Action 4 for the group of the field E.

At operation 210, the validation server 110 selects unique actions among the actions found in operation 208. As shown in the result 334, Action 4 is the unique action among the actions in that only one action is available to affect that grouping (also, the validation server 110 finds “Yes” at operation 210.) Thus, as shown in a result 336 in FIG. 3, the validation server 110 selects Action 4 as the unique action. In this embodiment, the validation server 110 applies the unique action to the fields in priority to other actions.

At operation 212, the validation server 110 creates branches for each possible application of the action. As already mentioned, the validation server 110 identifies the action that formed the difference. There are several ways in which a particular action can form a difference. For example, a branch can be formed depending on which system a particular action was only applied to. As another example, the validation server 110 may find more than one action to apply. In order to capture all of these possibilities, this disclosure will process all branches. However, in the example shown in FIG. 3, only a single branch will be used as an example. However, the actions are applied to all branches formed in operation 212 and omitted from the figures.

At operation 214, the validation server 110 applies the action previously identified. As shown in a State B-2 338 in FIG. 3, by applying Action 4 to State B, the validation server 110 creates the State B-2 with values 3, 2, 1, 4, and 5 for fields A, B, C, D, and E. To apply the action, the validation server 110 may add the values of the actions to the field to express putting the data into a post-manipulation state or subtract the values of the actions from the field to express putting the data into a pre-manipulation state.

At operation 216, the validation server 110 adds the action applied at operation 214 to a list to be returned to the user at operation 238. As such, the validation server repeatedly determines the action, applies the action, and determines the second difference until determining that the second difference satisfies the predetermined criteria.

After operation 216, the process moves back to operation 202, and the validation server 110 finds differences of the states based on each branch. As shown in a result 340 in FIG. 3, by applying operation 202 to the State B-2 338, the validation server 110 finds the differences of −2 in the field A and 2 in the field C (also finds “No” in operation 204.)

As shown in a result 342, by performing operation 206 to the result 340, the validation server 110 groups the mismatches in the fields A and C as both having magnitude 2.

As shown in a result 344, by performing operation 208 to the result 342, the validation server 110 finds a group of Action 1 and Action 2 for the group of the fields A and C.

After obtaining the result 344, the validation server 110, at operation 210, determines there is no unique action because both Action 1 and Action 2 belong to the group with another Action (also finds “No” at operation 210.) Then the process moves to operation 218.

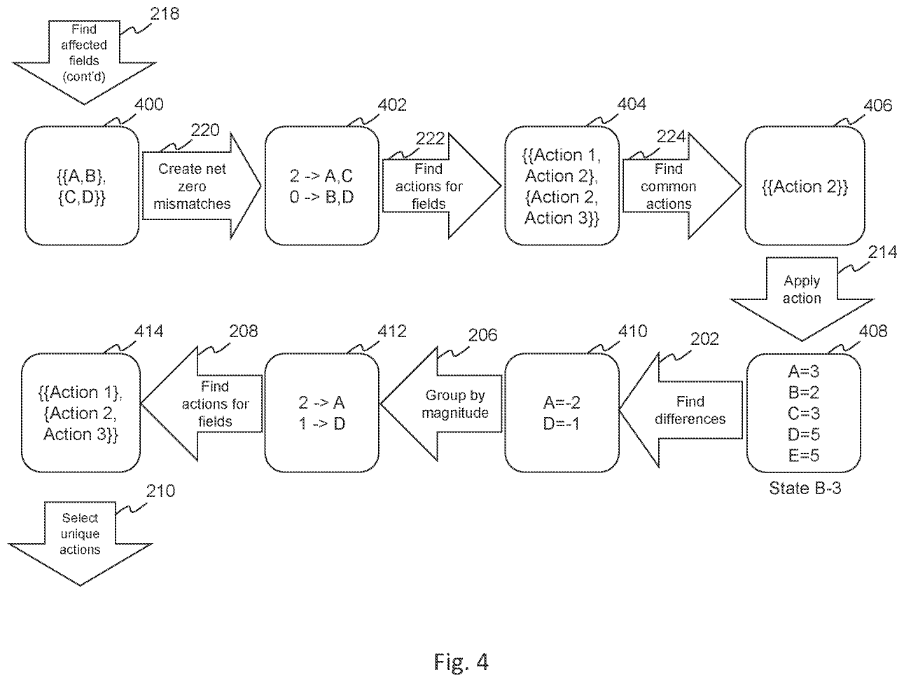

At operation 218, the validation server 110 finds fields affected by the actions found in operation 208. Since Action 1 affects fields A and B, and Action 2 affects fields C and D, as shown in a result 400 in FIG. 4, the validation server 110 finds these fields as the affected fields.

At operation 220, the validation server 110 creates net zero mismatches against the groups found at operation 218. Here, as shown in the result 340, there was no mismatch for the fields B and D. However, for future processing, the validation server 110 treats them as having a mismatch of “0”, as shown in result 402, for the sake of convenience. At operation 220, the validation server 110 also groups these mismatches by magnitude, like in operation 206.

At operation 222, the validation server finds actions for the fields identified at operation 220. As shown in a result 404 in FIG. 4, the validation server 110 finds a group of Action 1 and 2 as the actions, which affects the group of the fields A and C. The validation server 110 also finds a group of Action 2 and 3 as the actions, which affects the group of the fields B and D.

At operation 224, the validation server 110 finds common actions for the actions found at operation 222. As shown in a result 406 in FIG. 4, the validation server 110 finds Action 2 as the common action, because Action 2 belongs to both groups of actions in the result 404.

After creating new branches based on the common action found at operation 212, the validation server 110 applies the common action to the branches. As shown in a State B-3 408, at operation 214, by applying Action 2 to State B-2 338, the validation server 110 creates the State B-3 408 with values 3, 2, 3, 5, and 5 for fields A, B, C, D, and E.

After adding the applied action to the list, at operation 202, the validation server 110 finds differences of the states based on each branch. As shown in result 410, by applying operation 202 to the State B-3 408, the validation server 110 finds the differences of −2 in the field A and 1 in the field D (also finds “No” in operation 204.)

As shown in a result 412, by performing operation 206 to the result 410, the validation server 110 groups the mismatch in the field A having magnitude 2 and the field D having magnitude 1.

As shown in a result 414, by performing operation 208 to the result 412, the validation server 110 finds Action 1 for the field A and finds a group of Action 2 and Action 3 for the field D.

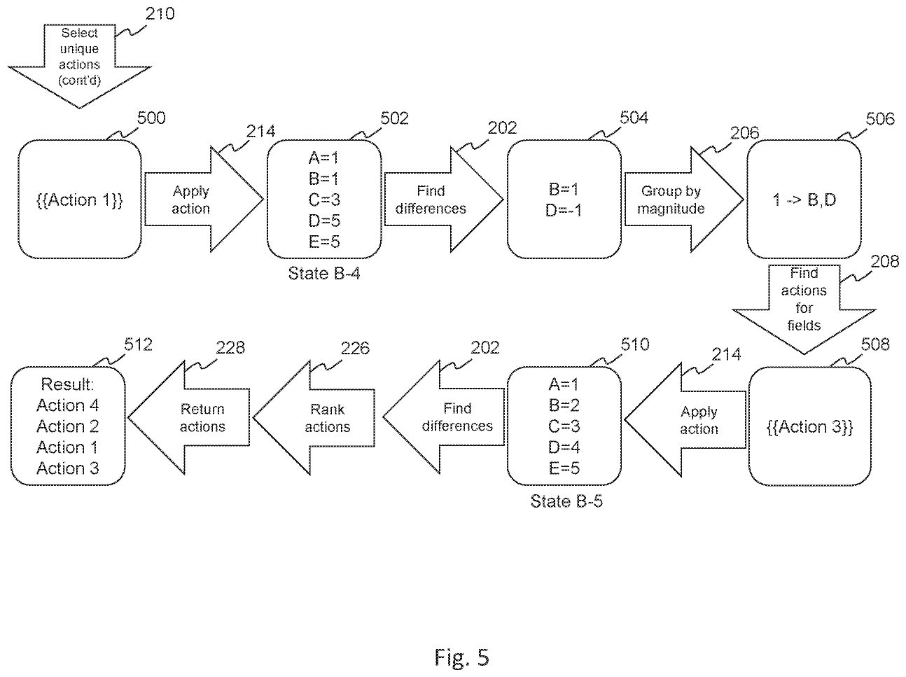

As shown in the result 414, Action 1 is the unique action among the actions (also the validation server 110 finds “Yes” at operation 210.) Thus, as shown in a result 500 in FIG. 5, the validation server 110 selects Action 1 as the unique action.

After creating new branches based on the unique action found at operation 212, the validation server 110 applies the unique action to the branches. As shown in a State B-4 502, at operation 214, by applying Action 1 to State B-3 408, the validation server 110 creates the State B-4 502 with values 1, 1, 3, 5, and 5 for fields A, B, C, D, and E.

After adding the applied action to the list, at operation 202, the validation server 110 finds differences of the states based on each branch. As shown in result 504, by applying operation 202 to the State B-4 502, the validation server 110 finds the differences of 1 in the field B and −1 in the field D (also finds “No” in operation 204.)

As shown in a result 506, by performing operation 206 to the result 504, the validation server 110 groups the mismatches in the field B and the field D having magnitude 1.

As shown in a result 508, by performing operation 208 to the result 506, the validation server 110 finds Action 3 for the field B and the field D and finds a group of Action 2 and Action 3 for the field D.

As shown in the result 508, Action 3 is the unique action (also the validation server 110 finds “Yes” at operation 210.) Thus, after creating new branches based on the found unique action, the validation server 110 applies the unique action to the branches. As shown in a State B-5 510, at operation 214, by applying Action 3 to State B-4 502, the validation server 110 creates the State B-5 510 with values 1, 2, 3, 4, and 5 for fields A, B, C, D, and E.

The validation server 110 finds that there are no differences between State B-5 510 and State A (also finds “Yes” in operation 204.) Then the process move to operation 226.

At operation 226, the validation server 110 ranks groups of actions. Multiple groups of actions may have been added to the list before reaching operation 226. This is because the validation server 110 recursively performs operations 202 through 216 for all possible branches. In such cases the validation server 110 ranks groups of actions according to some evaluation criteria. Examples of the evaluation criteria include the fewest number of actions, those statistically indicated to have the highest probability of occurrence, the fewest absolute values of varying field values, and a wide variety of others. In the example shown in FIG. 5, it is assumed that only one group of actions was found.

At operation 228, the validation server 110 returns actions ranked at operation 226. The validation server 110 can return actions in a variety of ways. For example, the validation server 110 may return actions by presenting the actions on a screen. The validation server 110 may also return actions by other means of expression, for example, by sending voice or text messages or predetermined signals. As shown in a result 512 in FIG. 5, the validation server 110 returns the result with Actions 4, 2, 1, and 3 and ends the validation operation at operation 230.

In this way, the user of the validation system 100 can identify the action that caused the mismatch. The series of processes performed by the validation server 110 greatly reduces the time and computer resources required for validation operations performed by ordinary computers, in that it does not validate all combinations of actions one by one, but only carefully selected combinations based on predetermined, established algorithms. When validation is performed using the brute force method, the validation may not be completed in a practical time depending on the number of actions, but the method of this disclosure can be used to identify actions in a realistic time.

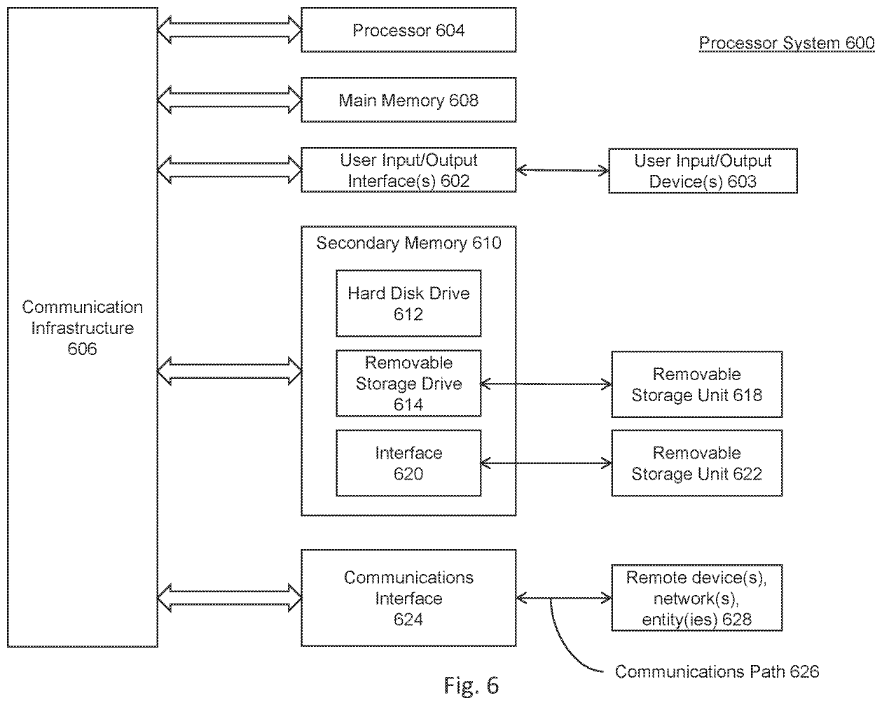

Various aspects of the above disclosure can be implemented, for example, using one or more processor systems, such as processor system 600 shown in FIG. 6. Processor system 600 can be any well-known computer capable of performing the functions described herein such as the validation server 110 of FIG. 1. Processor system 600 includes one or more processors (also called central processing units, or CPUs), such as a processor 604. Processor 604 is connected to a communication infrastructure 606 (e.g., a bus.) Processor system 600 also includes user input/output device(s) 603, such as monitors, keyboards, pointing devices, etc., that communicate with communication infrastructure 606 through user input/output interface(s) 602. Processor system 600 also includes a main or primary memory 608, such as random access memory (RAM). Main memory 608 may include one or more levels of cache. Main memory 608 has stored therein control logic (e.g., computer software) and/or data.

Processor system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 includes a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 reads from and/or writes to removable storage unit 618 in a well-known manner.

According to some aspects, secondary memory 610 may include other means, instrumentalities or other approaches for allowing computer programs and/or other instructions and/or data to be accessed by processor system 600. Such means, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Processor system 600 may further include communication or network interface 624. Communication interface 624 enables processor system 600 to communicate and interact with any combination of remote devices, remote networks, remote entities, etc. (individually and collectively referenced by reference number 628). For example, communication interface 624 may allow processor system 600 to communicate with remote devices 628 over communications path 626, which may be wired and/or wireless, and may include any combination of LANs, WANs, the Internet, etc. Control logic and/or data may be transmitted to and from processor system 600 via communication path 626.

The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, processor system 600, main memory 608, secondary memory 610 and removable storage units 618 and 622, as well as tangible articles of manufacture embodying any combination of the foregoing. Such control logic, when executed by one or more data processing devices (such as processor system 600), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 6. In particular, aspects may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, the Examiner is also reminded that any disclaimer made in the instant application should not be read into or against the parent application.

What is claimed is:

1. A computer-implemented method, comprising:
determining a first difference between a first data set and a second data set;
determining an action associated with the first difference;
applying the action to at least one of the first data set and the second data set;
determining a second difference between the first data set and the second data set after applying the action; and
presenting information including the action applied to at least one of the first data set and the second data set after determining that the second difference satisfies predetermined criteria.

2. The computer implemented method of claim 1, wherein:
the first data set and the second data set have a field with data; and
determining the first difference includes obtaining a difference of the data corresponding to the field between the first data set and the second data set.

3. The computer implemented method of claim 2, wherein:
the action is represented by manipulation of the data on the field;
determining the action includes determining the action with the manipulation of the data over the field with the difference; and
applying the action includes putting the data into a post-manipulation state or putting the data into a pre-manipulation state.

4. The computer implemented method of claim 3, wherein:
determining the action includes determining a plurality of actions; and
applying the action includes determining whether the plurality of actions includes a unique action that manipulates the data over the field with the difference and applying the unique action in priority to other actions after determining that the plurality of actions includes the unique action.

5. The computer implemented method of claim 3, wherein:
determining the action includes determining a plurality of groups of the action; and
applying the action includes determining a common action among the plurality of the groups of the action and applying the common action.

6. The computer implemented method of claim 1, further comprising:
repeatedly determining the first difference, determining the action, applying the action, and determining the second difference, until determining that the second difference satisfies the predetermined criteria.

7. The computer implemented method of claim 1, wherein:
presenting the information includes presenting a plurality of groups of the action in a manner that indicates a ranking among the plurality of groups of the action.

8. A validation system, comprising:
a validation server comprising:
circuitry configured to;
receive a first data set and a second data set;
determine a first difference between the first data set and the second data set;
determine an action associated with the first difference;
apply the action to at least one of the first data set and the second data set;
determine a second difference between the first data set and the second data set after applying the action; and
present information including the action applied to at least one of the first data set and the second data set after determining that the second difference satisfies predetermined criteria.

9. The validation system according to claim 8, wherein:
the first data set and the second data set have a field with data; and
determining the first difference includes obtaining a difference of the data corresponding to the field between the first data set and the second data set.

10. The validation system according to claim 9, wherein:
the action is represented by manipulation of the data on the field;
determining the action includes determining the action with the manipulation of the data over the field with the difference; and
applying the action includes putting the data into a post-manipulation state or putting the data into a pre-manipulation state.

11. The validation system according to claim 10, wherein:
determining the action includes determining a plurality of actions; and
applying the action includes determining whether the plurality of actions includes a unique action that manipulates the data over the field with the difference and applying the unique action in priority to other actions after determining that the plurality of actions includes the unique action.

12. The validation system according to claim 10, wherein:
determining the action includes determining a plurality of groups of the action; and
applying the action includes determining a common action among the plurality of the groups of the action and applying the common action.

13. The validation system according to claim 8, the circuitry further comprising:
repeatedly determining the first difference, determining the action, applying the action, and determining the second difference, until determining that the second difference satisfies the predetermined criteria.

14. The validation system according to claim 8, wherein:
presenting the information includes presenting a plurality of groups of the action in a manner that indicates a ranking among the plurality of groups of the action.

15. A computer readable storage device having instructions stored thereon, execution of which, by one or more processing devices, causes the one or more processing devices to perform operations comprising:
determining a first difference between a first data set and a second data set;
determining an action associated with the first difference;
applying the action to at least one of the first data set and the second data set;
determining a second difference between the first data set and the second data set after applying the action; and
presenting information including the action applied to at least one of the first data set and the second data set after determining that the second difference satisfies predetermined criteria.

16. The computer readable storage device according to claim 15, wherein:
the first data set and the second data set have a field with data; and
determining the first difference includes obtaining a difference of the data corresponding to the field between the first data set and the second data set.

17. The computer readable storage device according to claim 16, wherein:
the action is represented by manipulation of the data on the field;
determining the action includes determining the action with the manipulation of the data over the field with the difference; and
applying the action includes putting the data into a post-manipulation state or putting the data into a pre-manipulation state.

18. The computer readable storage device according to claim 17, wherein:
determining the action includes determining a plurality of actions; and
applying the action includes determining whether the plurality of actions includes a unique action that manipulates the data over the field with the difference and applying the unique action in priority to other actions after determining that the plurality of actions includes the unique action.

19. The computer readable storage device according to claim 17, wherein:
determining the action includes determining a plurality of groups of the action; and
applying the action includes determining a common action among the plurality of the groups of the action and applying the common action.

20. The computer implemented method of claim 15, wherein:
presenting the information includes presenting a plurality of groups of the action in a manner that indicates a ranking among the plurality of groups of the action.
